(19) United States
(12) Patent Application Publication
(10) Pub. No.: US 2009/0161522 A1
(43) Pub. Date: Jun. 25, 2009

(54) Apparatus for Reproducing and/or Recording and Recording Medium

(76) Inventor: Yun Sup Shin, Gyeonggi-do (KR)

Correspondence Address: HARNESS, DICKEY & PIERCE, P.L.C., P.O. BOX 8910, RESTON, VA, 20195, US

(21) Appl. No.: 11/992,010

(22) PCT Filed: Sep. 15, 2006
(86) PCT No.: PCT/KR2006/003693

§ 371 Date: Mar. 14, 2008

(30) Foreign Application Priority Data
Jan. 10, 2006 (KR) 1020060002822
Apr. 28, 2006 (KR) 1020060038927
Jun. 29, 2006 (KR) 1020060059512

(51) Int. Cl. G11B 7/00

(52) U.S. Cl. 369/112.24; G9B/7

(57) ABSTRACT

An apparatus for reproducing and/or recording a recording medium (50) are disclosed. For example, the apparatus includes a lens unit (40) consisting of a near-field lens (42), which takes the form of a part of a sphere and has a thickness larger than a radius of the sphere and smaller than a diameter of the sphere, and an objective lens (41) for compensating for spherical aberration of the near-field lens. When the recording medium includes a protective layer (52) for isolating the recording layers from the outside, an effective numerical aperture of the lens unit is smaller than a refractive index of the protective layer. The recording medium further includes one or more recording layers (51). The apparatus has an advantage of providing the lens unit suitable for a near field and easy to manufacture and the recording medium including the protective layer or spacer layer suitable for a near field.

### TECHNICAL FIELD

The present invention relates to an apparatus for reproducing and/or recording and a recording medium, and more particularly, to lens unit included in the apparatus and a recording medium for use in the apparatus.

### BACKGROUND ART

Generally, an optical recording/playback apparatus is an apparatus for recording data in a recording medium, such as a compact disc (CD), digital versatile disc (DVD), etc., or playing back data recorded in the recording medium. With upgraded consumer's taste, a necessity for the processing of high-definition moving images is on the rise, and a development in the compression technologies of moving images causes a necessity for a high-density recording medium. One of critical technologies required to develop the high-density recording medium is a technology related to an optical head, i.e. optical pickup.

In the above described recording medium, a recording density may depend on the diameter of a light beam to be irradiated to a recording layer of the recording medium. The smaller the diameter of a focused light beam to be irradiated to the recording medium, the higher the recording density. In this case, the diameter of the focused light beam is basically determined by two factors. One of the factors is an effective numerical aperture (NA) indicative of the performance of a lens, and the other factor is the wavelength of a light beam to be focused to the lens.

The shorter the wavelength of the focused light beam, the greater the recording density. Therefore, a short wavelength light beam is used to increase the recording density. Specifically, when using a blue light beam rather than a red light beam, the greater recording density can be achieved. However, a far-field recording using a general lens has a limit to reduce the diameter of a light beam because of a limitative light diffraction thereof. For this reason, a near-field recording (NFR) apparatus using a near-field, which is capable of storing or reading information having a smaller bit size than that of the wavelength of a light beam, is being developed.

A near-field optical recording apparatus using lenses is adapted to obtain a light beam less than a diffraction limit by use of a lens having a higher refractive index than that of an objective lens. The resulting light beam is propagated in the form of an evanescent wave to a recording medium near an interface, to store high-density bit information. FIG. 1 is a simplified diagram illustrating lenses included in a near-field optical recording apparatus for irradiating a light beam to a recording medium and also illustrating a part of the recording medium. As shown, a lens unit of the near-field optical recording apparatus may be configured such that a light beam focused by an objective lens 111 passes through a lens 112 having a high refractive index. If the light beam is incident on the high refractive index lens 112 by an angle more than a critical angle, the light beam is totally reflected while leaving the high refractive index lens 112, thereby allowing a slight intensity of light beam to be produced at a surface of the lens. That is, an evanescent wave less than a diffraction limit is produced. The evanescent wave enables a high resolution that was impossible in a recording apparatus using a single lens because of the diffraction limit of a wavelength. In this case, by positioning the high refractive index lens 112 near a recording medium 113 by a very close distance less than 100 nm, a near field capable of storing high-density bit information by the evanescent wave is produced. Here, a region producing the evanescent wave as stated above is referred to as a near field for the convenience of explanation.

However, the above described prior art has the following problems.

Firstly, it is difficult to manufacture a lens suitable for the above described near-field recording/playback apparatus for the pursuit of raising a recording density and minimizing errors in manufacture.

Secondly, the near-field optical recording apparatus uses an evanescent wave having a very short wavelength, and therefore, has a difficulty to define a recording medium suitable for the evanescent wave.

Thirdly, if a recording medium used in the near-field optical recording apparatus includes a plurality of recording layers or a surface protective layer, it is difficult to regulate accurate irradiation of a light beam to the respective recording layers of the recording medium.

### DISCLOSURE OF INVENTION

An object of the present invention is to provide a lens suitable for a near-field recording/playback apparatus and the recording/playback apparatus having the same.

Another object of the present invention is to provide a recording medium having a protective layer and a recording/playback apparatus capable of using the recording medium.

Yet another object of the present invention is to provide a recording medium having a plurality of recording layers and a recording/playback apparatus capable of using the recording medium.

The object of the present invention can be achieved by providing a recording/playback apparatus comprising: an optical pickup comprising a lens unit and a photo-detector, the lens unit comprising a high refractive index lens having a spherical aberration and an objective lens for compensating for the spherical aberration of the high refractive index lens and irradiating a light beam emitted from an optical source to a recording medium, the photo-detector being adapted to receive a light beam reflected from the recording medium; and a controller for generating a control signal by use of a signal generated from the photo-detector. Here, the high refractive index lens may be a part of a spherical lens and may have a thickness larger than a radius of the spherical lens and smaller than a diameter of the spherical lens. The objective lens may have a spherical aberration having the same size as that of the high refractive index lens, but having a direction opposite to that of the high refractive index lens. An effective numerical aperture of the lens unit may be smaller than a refractive index of a protective layer included in the recording medium used in the recording/playback apparatus. In particular, when the high refractive index lens is made of glass, and the effective numerical aperture of the lens unit may be equal to or larger than 1.6 and equal to or smaller than 1.85.

In accordance with another aspect of the present invention, an optical pickup included in a recording/playback apparatus further comprises a focus control unit provided separately from a lens unit. Here, the focus control unit may comprise at least one lens movable in an optical axis direction. Alternatively, the focus control unit may comprise a first control lens having a fixed position and a movable second control lens, and is adapted to change a path of a light beam by moving the second control lens in an optical axis direction.

The recording medium for use in the recording/playback apparatus of the present invention comprises: one or more recording layers; and at least one protective layer for isolating the recording layers from the outside, a refractive index of the protective layer being larger than the effective numerical aperture of the lens unit that is used to irradiate the light beam to the recording medium. The protective layer may be provided at a surface of the recording medium, and may have a thickness in a range of 10 nm˜25 μm.

The recording medium may further comprise at least one spacer layer spacing the recording layers apart from each other or spacing the recording layers apart from the protective layer. The spacer layer may have a thickness in a range of 1 μm˜25 μm. A refractive index of the spacer layer may be larger than the effective numerical aperture of the lens unit. Here, the sum of the thicknesses of the protective layer and spacer layer may be a maximum of 25 μm.

### BRIEF DESCRIPTION OF DRAWINGS

The accompanying drawings, which are included to provide a further understanding of the invention, illustrate embodiments of the invention and together with the description serve to explain the principle of the invention.

In the drawings:

FIG. 1 is a schematic sectional view illustrating a part of an optical pickup included in a general near-field optical recording apparatus.

FIG. 2 is a block diagram illustrating the configuration of a recording/playback apparatus according to a first embodiment of the present invention.

FIG. 3 is a block diagram illustrating an optical pickup included in the recording/playback apparatus according to the first embodiment of the present invention.

FIG. 4 is a schematic sectional view illustrating a lens unit of the optical pickup and a recording medium according to the first embodiment of the present invention.

FIGS. 5A to 5C are sectional views illustrating different near-field lenses for use in the recording/playback apparatus according to the present invention.

FIG. 6 is an interrelationship graph illustrating a variation of spherical aberration depending on a variation in the thickness of a near-field lens.

FIGS. 7A and 7B are schematic sectional views, respectively, illustrating a near-field lens and a lens unit including an objective lens for compensating for the spherical aberration of the near-field lens.

FIG. 8 is a block diagram illustrating an optical pickup included in the recording/playback apparatus according to a second embodiment of the present invention.

FIG. 9 is a schematic sectional view illustrating one example of a focus control unit included in the optical pickup and the recording medium.

FIG. 10 is a schematic side sectional view illustrating another example of the focus control unit included in the optical pickup.

FIG. 11 is an enlarged partial sectional view and perspective view of the recording medium.

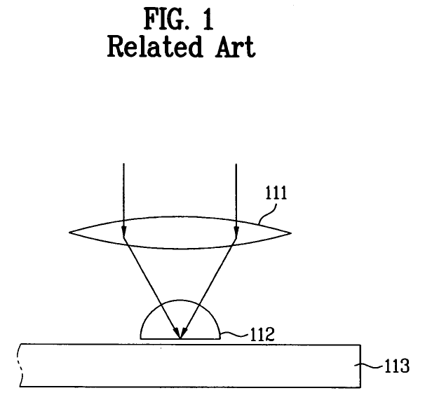

### BEST MODE FOR CARRYING OUT THE INVENTION

Reference will now be made in detail to an optical pickup and recording medium according to the preferred embodiments of the present invention, examples of which are illustrated in the accompanying drawings. Herein, the term “recording medium” indicates all mediums capable of recording data therein or having data recorded therein. A representative example of the recording medium is an optical disc. Also, the term “recording/playback apparatus” indicates all apparatuses capable of recording data in the recording medium or playing back the data recorded in the recording medium. Although a recording/playback apparatus using a near-field is described herein for the convenience of explanation, it should be noted that the scope of the present invention is not limited to the following embodiments.

Prior to describing the present invention, also, it should be noted that most terms disclosed in the present invention correspond to general terms well known in the art, but some terms have been selected by the applicant as necessary and will be disclosed in detail in the following description of the present invention. Therefore, it is preferable that the terms defined by the applicant be understood on the basis of their meanings in the present invention.

Now, the recording/playback apparatus according to the preferred embodiments of the present invention will be explained with reference to the drawings. Wherever possible, the same reference numbers will be used throughout the drawings to refer to the same or like parts.

### First Embodiment

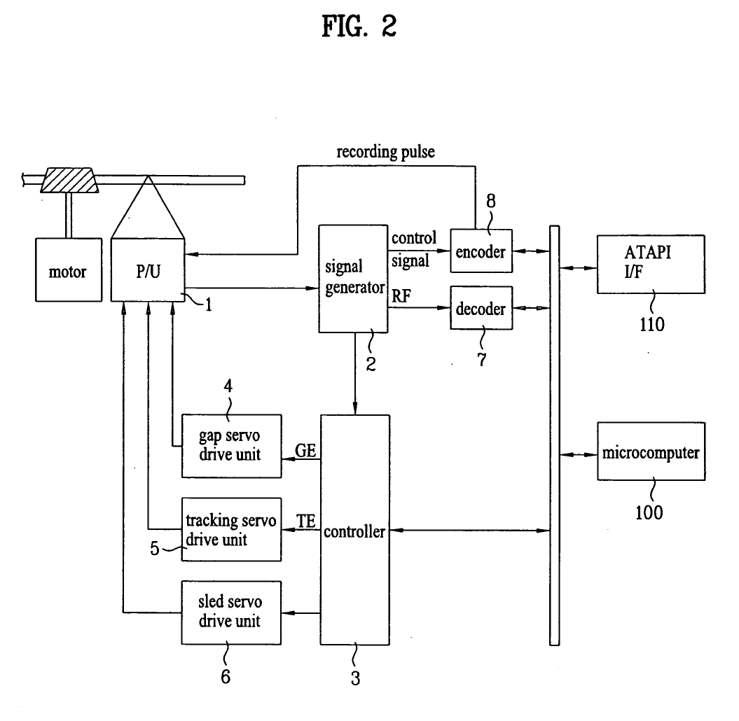

FIG. 2 schematically illustrates the configuration of a recording/playback apparatus according to a first embodiment of the present invention. The configuration of the recording/playback apparatus will be explained in detail with reference to the other drawings as well as FIG. 2.

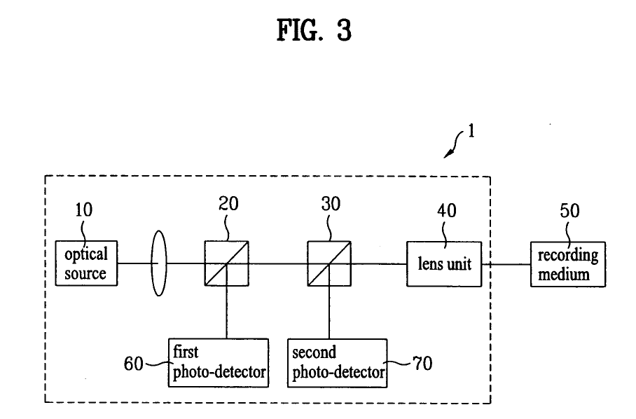

An optical pickup (P/U) 1 serves to generate a signal by irradiating a light beam to a recording medium and collecting a light beam reflected from the recording medium. An optical system (not shown) constituting the optical pickup 1 may be configured as shown in FIG. 3. Specifically, the optical system included in the optical pickup 1 may include an optical source 10, separation/combination units 20 and 30, lens unit 40 and photo-detectors 60 and 70. Now, these constituent elements included in the optical pickup 1 will be explained in detail.

The optical source 10 may emit a laser beam having a superior directionality, etc. More particularly, the optical source 10 may be a laser diode. A lens, such as a collimating lens causing optical paths to be parallel to each other, may be provided on a path of the light beam emitted from the optical source 10, to allow parallel light beams to be irradiated to a recording medium.

The separation/combination units 20 and 30 serve to separate paths of light beams incident thereon in the same direction as one another, or combine paths of light beams incident thereon in different directions from one another. The present embodiment employs first and second separation/combination units 20 and 30, which will be described in sequence. The first separation/combination unit 20 is adapted to pass a part of the light beams incident thereon and reflect the remaining part of the light beams. For example, the first separation/combination unit 20 may be a non-polarized beam splitter (NBS). The second separation/combination unit 30 is adapted to pass only a light beam that is polarized in a particular direction selected based on a polarization direction. For example, the second separation/combination unit 30 may be a polarized beam splitter (PBS). Specifically, the second separation/combination unit 30 may be configured to pass a vertical component of a linearly polarized light beam and reflect a horizontal component of the polarized light beam, or to pass the horizontal component of the polarized light beam and reflect the vertical component of the polarized light beam.

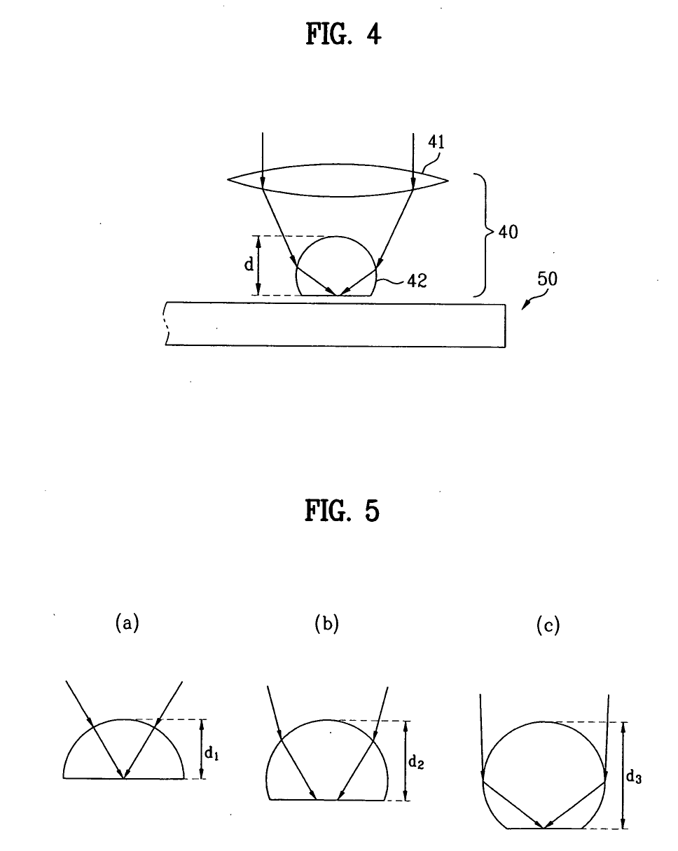

The lens unit 40 serves to irradiate the light beam emitted from the optical source 10 to a recording medium 50. More particularly, the lens unit 40 according to the embodiment of the present invention, as shown in FIG. 4, includes an objective lens 41 and a high refractive index lens 42 provided on a path of the light beam having passed through the objective lens 41 to be incident on the recording medium. With the provision of the high refractive index lens 42 in addition to the objective lens 41, it is possible to increase a numerical aperture of the lens unit 40, and consequently, to produce an evanescent wave. In the following description, the high refractive index lens 42 will be referred to as “near-field lens” for the convenience of explanation.

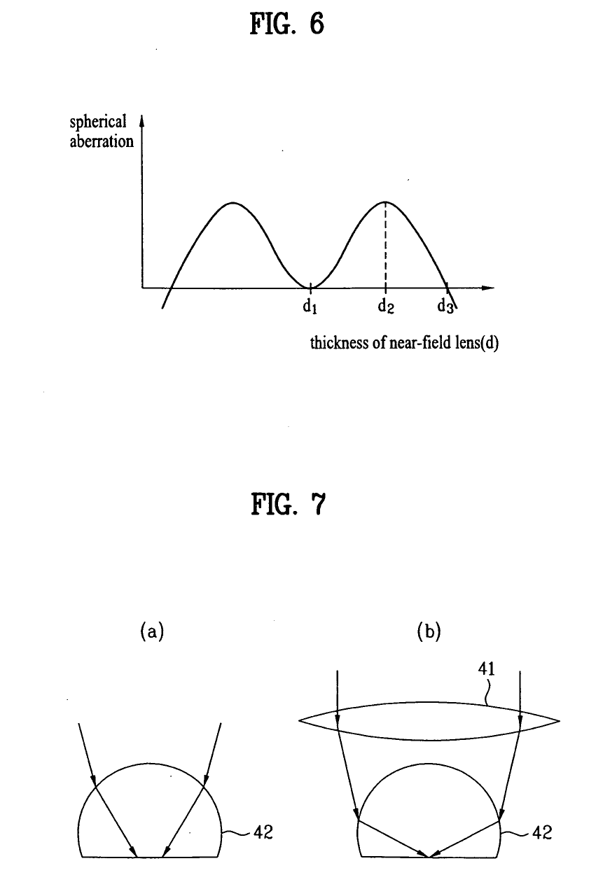

Now, the configuration of the near-field lens will be explained in detail with reference to FIGS. 5 and 6. The near-field lens 42 may be a solid immersion lens (SIL), and may have a semi-spherical or extra semi-spherical shape obtained by cutting a spherical lens. Here, the term “extra semi-spherical” indicates a partial spherical shape having an intermediate thickness between those of a sphere and semi-sphere. Specifically, by cutting one end of a spherical lens, a variety of sizes of near-field lenses 42 having different thicknesses from one another as shown in FIGS. 5A to 5C can be obtained. In this case, the cut section of the near-field lens 42 may be additionally cut to have a conical shape, and in particular, a distal end portion of the resulting conical section may have an area sufficient to allow a light beam to be focused thereon.

FIG. 6 illustrates a variation of spherical aberration depending on the thickness of the near-field lens 42 (here, spherical aberrations of the respective cases shown in FIGS. 5A to 5C are designated at positions d1, d2 and d3). As shown, in the case where the near-field lens 42 has a thickness d1 or d3, there is no spherical aberration, and this is called an aplanatic point. Accordingly, with the use of the near-field lens 42 having a thickness representing no spherical aberration as shown in FIG. 5A or 5C, it is possible to minimize the effect by spherical aberration.

However, the semi-spherical lens shown in FIG. 5A has a problem of a relatively low numerical aperture (NA). The NA is indicative of a lens performance, and may be defined as n sin θ in the case of the semi-spherical lens as shown in FIG. 5A. Here, “n” is indicative of a refractive index of a medium through which a light beam passes, and “θ” is indicative of the maximum value of an angle defined between an optical axis and the light beam passing through the lens. Specifically, the greater the refractive index n of the medium or the angle θ, the greater the NA and resolving power discriminating two close points. On the other hand, the NA may be defined as n² sin θ in the case of the extra semi-spherical lens as shown in FIG. 5C. Accordingly, the extra semi-spherical lens shown in FIG. 5C has a larger NA than that of the semi-spherical lens shown in FIG. 5A, and is more preferable in a near-field recording/playback apparatus. However, the extra semi-spherical lens shown in FIG. 5C has a difficulty in manufacture. As shown in FIG. 6, spherical aberration shows a rapid gradient at the position d3 indicative of the extra semi-spherical lens. This means that the extra semi-spherical lens may have a serious error in spherical aberration if a thickness thereof is inaccurately formed in manufacture. Therefore, the extra semi-spherical lens has to be cut to have an accurate thickness, and suffers from a difficulty in manufacture.

For the above described reasons, it is preferable to manufacture and use the near-field lens 42 as shown in FIG. 5B because the near-field lens 42 can be easily manufactured while achieving a larger NA than that of the semi-spherical lens. In this case, the spherical aberration of the near-field lens 42 shown in FIG. 5B can be compensated by use of the objective lens 41.

FIG. 7 illustrates the lens unit 40 including the near-field lens 42 having a thickness approximate to the thickness d2 of FIG. 5B and the objective lens 41 compensating for the spherical aberration of the near-field lens 42. Here, the objective lens 41 is designed to have a spherical aberration, which has the same size as that of the near-field lens 42, but has a direction opposite to that of the near-field lens 42. With this configuration, the lens unit 40 can be manufactured easily while achieving the efficient compensation of spherical aberration as well as large numerical aperture. In the case of the lens having a thickness approximate to the thickness d2, as shown in FIG. 6, spherical aberration thereof varies along a gentle curve in accordance with a thickness variation thereof. Therefore, the lens can efficiently reduce the range of errors in manufacture. In particular, since the gradient of a tangent line becomes zero at a local maximum point of spherical aberration, the efficiency of the lens can be further increased. Specifically, if the near-field lens 42 is manufactured to have a thickness d2 representing the local maximum point of spherical aberration, it has no significant variation of spherical aberration in spite of an error in thickness. Accordingly, the lens unit 40, in which spherical aberration thereof is compensated accurately by use of the objective lens 41, can be manufactured.

In this case, an effective numerical aperture (NA_{eff}) obtained by both the objective lens 41 and near-field lens 42 is restricted when the recording medium has a protective layer. Specifically, to prevent a light beam irradiated to the recording medium 50 from being totally reflected from the protective layer of the recording medium 50, it is preferable that the NA_{eff} be smaller than a refractive index of the protective layer. Here, the NA_{eff} indicates a numerical aperture of the entire lens unit 40 including the objective lens 41 and near-field lens 42.

Generally, the refractive index of the protective layer is approximately 1.6 for the wavelength of 405 nm when the protective layer is made of a polycarbonate-based material. However, if the protective layer is made of an acrylate-based material, the refractive index thereof is approximately 1.75˜1.85. That is, in consideration of the refractive index of the protective layer, the NA_{eff} has a threshold value approximately in the range of 1.75˜1.85. For example, if the near-field lens 42 is made of glass (more particularly, glass LasF35 or LAM79 having a refractive index more than 1.8, etc.), the NA_{eff} has a threshold value of 1.85. An appropriate range of the NA_{eff} for producing a minimum diameter of light beam on the recording medium 50 is approximately 1.6˜1.85 within the range of the above mentioned threshold value.

On the other hand, if the recording medium 50 has no protective layer and thus, has a recording layer at a surface thereof, the NA_{eff} is not affected by the refractive index of the recording medium 50. Therefore, the near-field lens 42 may be manufactured by use of high-refractive index diamond, and the like, and have the NA_{eff} more than 2.0.

The optical system of the optical pickup including the lens unit 40 is located very close to the recording medium 50. An arrangement thereof is described below in detail. For example, if the lens unit 40 and recording medium 50 are positioned close to each other by a distance less than approximately ¼ of the wavelength of a light beam (i.e. λ/4), an evanescent wave produced in the lens unit 40 maintains its nature and can be used to record or play back data in or from the recording medium 50. However, if the distance between the lens unit 40 and the recording medium 50 exceeds λ/4, the wavelength of a light beam loses the nature of evanescent wave and returns to its original state. Accordingly, in the recording/playback apparatus using a near field, conventionally, the distance between the lens unit 40 and the recording medium 50 is maintained so as not to exceed approximately λ/4. Here, the value λ/4 is a threshold value of a near field.

Referring again to FIG. 3, the photo-detectors 60 and 70 serve to receive the reflected light beam and perform a photoelectric conversion, so as to generate an electric signal corresponding to the quantity of the reflected light beam. The present embodiment employs first and second photo-detectors 60 and 70. Specifically, the first and second photo-detectors 60 and 70 may be divided, for example, bisected in a particular manner along a signal track direction or radial direction of the recording medium 50, to take the form of two photo-detecting devices PDA and PDB. Here, the respective photo-detecting devices PDA and PDB generate electric signals A and B in proportion to the quantity of light beams incident thereon. Alternatively, the first and second photo-detectors 60 and 70 may include four photo-detecting devices PDA, PDB, PDC and PDD obtained by bisecting each of the photo-detectors 60 and 70 along the signal track direction and radial direction of the recording medium 50. Here, it will be appreciated that the configuration of the photo-detecting devices constituting the photo-detectors 60 and 70 is not limited to the present embodiment, and a variety of modifications thereof are possible as needed.

Referring again to FIG. 2, a signal generator 2 serves to generate an RF signal required to play back data, a gap error (GE) signal required for a servo control, a tracking error (TE) signal, etc. by use of the signals generated from the optical pickup 1.

A controller 3 serves to generate a control signal or drive signal by receiving the signals generated from the photo-detectors 60 and 70 or signal generator 2. For example, the controller 3 outputs a drive signal, which is required to control the distance between the lens unit 40 and the recording medium 50, to a gap servo drive unit 4 by processing the GE signal. Alternatively, the controller 3 outputs a drive signal for a tracking control to a tracking servo drive unit 5 by processing the TE signal.

The gap servo drive unit 4 serves to move the optical pickup 1 or lens unit 40 thereof vertically by driving an actuator (not shown) received in the optical pickup 1. Thereby, the distance between the lens unit 40 and the recording medium 50 can be maintained at a constant value. The gap servo drive unit 4 may also perform the role of a focus servo. For example, the optical pickup 1 or lens unit 40 thereof may be designed to follow the rotation and vertical movement of the recording medium 50 on the basis of a focus control signal from the controller 3.

The tracking servo drive unit 5 serves to move the optical pickup 1 or lens unit 40 thereof in a radial direction by operating a tracking actuator (not shown) received in the optical pickup 1, so as to correct the position of a light beam. Thereby, the optical pickup 1 or lens unit 40 thereof may follow a predetermined track provided on the recording medium 50. Also, the tracking servo drive unit 5 may move the optical pickup 1 or lens unit 40 thereof in a radial direction in response to a track movement command.

A sled servo drive unit 6 is able to move the optical pickup 1 in a radial direction in response to the track movement command by operation of a sled motor (not shown) that is provided to move the optical pickup 1.

The above described recording/playback apparatus may be connected to a host, such as a personal computer. The host transmits a recording/playback command to a microcomputer 100 through an interface, receives played back data from a decoder 7, and transmits data to be recorded to an encoder 8. The microcomputer 100 controls the decoder 7, encoder 8 and controller 3 based on the recording/playback command of the host.

Here, the interface may be a conventional advanced technology attachment packet interface (ATAPI) 110. The ATAPI 110 is a standard interface between the host and an optical recording/playback apparatus, such as a CD or DVD drive, and is proposed to transmit data decoded in the optical recording/playback apparatus to the host. That is, the ATAPI 110 serves to convert the decoded data into a packet protocol, which is data to be processed in the host, so as to transmit the protocol.

Hereinafter, the operational sequence of the optical pickup 1 included in the recording/playback apparatus of the present embodiment will be described in detail, on the basis of an advance direction of a light beam emitted from the optical source 10 within the optical system and on the basis of a signal flow in other regions.

The light beam emitted from the optical source 10 of the optical pickup 10 is incident on the first separation/combination unit 20 such that a part of the light beam is reflected and the remaining part of the light beam passes through the first separation/combination unit 20 to be incident on the second separation/combination unit 30. The second separation/combination unit 30 passes only a vertical component of a linearly polarized light beam and reflects a horizontal component of the polarized light beam (or vice versa). A polarization converting plane (not shown) may be additionally provided on a path of the light beam having passed through the second separation/combination unit 30. The polarization converting plane will be described hereinafter in detail.

The light beam, having passed through the second separation/combination unit 30, is incident on the lens unit 40. Here, the light beam is first incident on the objective lens of the lens unit 40, and then, produces an evanescent wave while passing through the near-field lens. More particularly, the light beam, which is incident on the near-field lens by an angle more than a critical angle, is totally reflected from a surface of the near-field lens and a surface of the recording medium 50. Also, the light beam, which is incident on the near-field lens by an angle less than the critical angle, is reflected from a recording layer of the recording medium 50. The evanescent wave produced while passing through the near-field lens reaches the recording layer of the recording medium, to perform a recording/playback operation.

The light beam reflected from the recording medium 50 is again incident on the second separation/combination unit 30 by passing through the lens unit 40. As stated above, the polarization converting plane (not shown) may be provided on a path of the light beam incident on the second separation/combination unit 30. The polarization converting plane converts a polarization direction of the light beam incident on and reflected from the recording medium 50. For example, if a quarter wave plate (QWP) is used as the polarization converting plane, the QWP polarizes the light beam to be incident on the recording medium 50 leftward and the reverse light beam reflected from the recording medium 50 rightward. In conclusion, the reflected light beam having passed through the QWP is converted to have a different polarization direction from that of the incident light beam, and more particularly, the reflected and incident light beams have a difference of 90°. Accordingly, when only a horizontal component of the polarized light beam passes through the second separation/combination unit 30 to be incident on the recording medium 50, the incident light beam is reflected from the recording medium 50 such that only a vertical component of the polarized light beam is incident again on the second separation/combination unit 30. Thereby, the vertical component of the polarized light beam is reflected from the second separation/combination unit 30, to thereby be incident on the second photo-detector 70. Meanwhile, in the near-field recording/playback apparatus of the present invention, since the NA of the lens unit 40 is larger than 1, the light beam has a distortion in polarization direction in the course of being irradiated through and reflected from the lens unit 40. Specifically, a part of the reflected light beam incident on the second separation/combination unit 30 has a horizontal component of the polarized light beam by the distortion of the polarization direction, and passes through the second separation/combination unit 30. The reflected light beam having passed through the second separation/combination unit 30 is incident on the first separation/combination unit 20. The first separation/combination unit 20 passes a part of the light beam incident thereon, and reflects the remaining part of the light beam. The light beam reflected from the first separation/combination unit 20 is incident on the first photo-detector 60.

The first and second photo-detectors 60 and 70 output electric signals corresponding to the quantity of the light beams incident thereon. The signal generator 2 generates an RF signal, GE signal, a TE signal, etc. by use of the electric signals outputted from the photo-detectors 60 and 70. For example, when each of the first and second photo-detectors 60 and 70 includes two photo-detecting devices, the two photo-detecting devices of the first photo-detector 60 output electric signals A and B corresponding to the quantity of the light incident thereon. Also, the two photo-detecting devices constituting the second photo-detector 70 output electric signals C and D corresponding to the quantity of the light incident thereon. On the basis of the signals A and B outputted from the first photo-detector 60, the signal generator 2 is able to generate a GE signal for controlling the distance between the lens unit and the recording medium. Specifically, the GE signal is generated by adding all the signals A and B outputted from the photo-detecting devices of the first photo-detector 60. Since the GE signal is proportional to the distance between the lens unit 40 and the recording medium 50, it is possible to control the distance by use of the GE signal. Also, the signal generator 2 is able to generate an RF signal, tracking error signal, etc. by use of the signals generated from the second photo-detector 70. In this way, recording or playback of accurate data is possible.

### Second Embodiment

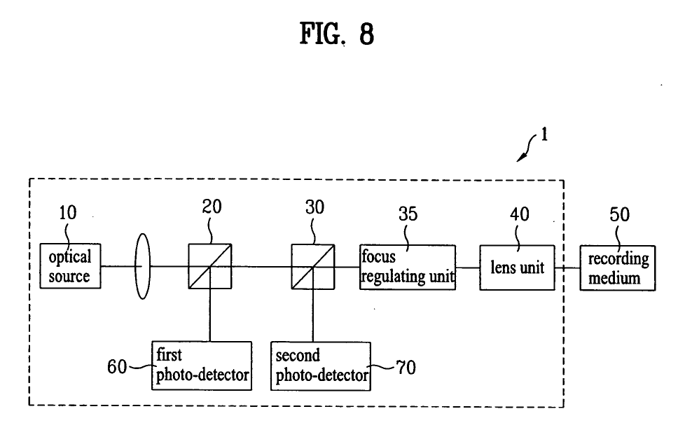

An optical pickup included in the recording/playback apparatus according to the second embodiment of the present invention may be configured as shown in FIG. 8. Specifically, in addition to the configuration of the above described first embodiment, the present embodiment may include a focus control unit 35. In the following description, the same configuration as that of the first embodiment will not be described for the convenience of explanation. The focus control unit 35 serves to change a focus position of a light beam to be irradiated to the recording medium 50. As stated above, in the recording/playback apparatus using a near field, the lens unit 40 and recording medium 50 have to be located close to each other for the use of an evanescent wave. For this reason, the focus control unit 35 may be provided separately from the lens unit 40 because it is difficult to directly move the lens unit 40 axially.

The focus control unit 35 is provided on an optical axis and includes at least one movable lens. The focus control unit 35 serves to change an advance path of a light beam, so as to change the focus position of the light beam.

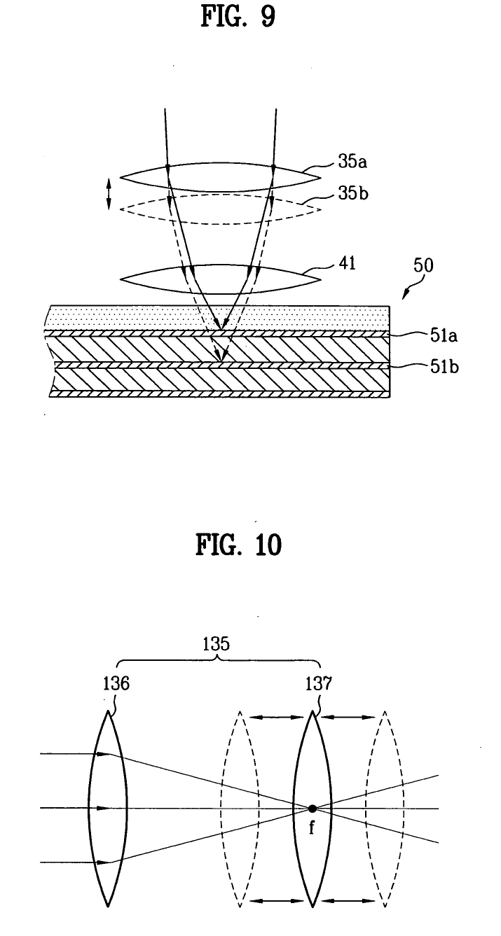

Now, one example of the focus control unit 35 will be described with reference to FIG. 9.

The focus control unit 35 may take the form of a single lens movable along an optical axis. As the focus control unit 35 moves, for example, from a first position 35a to a second position 35b as shown in FIG. 9, an irradiation position of a light beam on the recording medium 50 may be displaced from a first recording layer 51a to a second recording layer 51b. Specifically, the light beam irradiated to the recording medium 50 by passing through the objective lens 41 is focused on the first recording layer 51a of the recording medium 50 when the focus control unit 35 is located at the first position 35a (designated as a solid line). On the other hand, the light beam irradiated to the recording medium 50 is focused on the second recording layer 51b of the recording medium 50 when the focus control unit 35 is located at the second position 35b (designated as a dotted line). Thereby, it is possible to change the position of the light beam to be focused on the recording medium 50 by control the position of the focus control unit 35 without moving the objective lens 41.

Another example of the focus control unit will be explained with reference to FIG. 10.

The focus control unit 135 may include two lenses. In this case, a first control lens 136 is kept at a fixed position, and a second control lens 137 is movable as shown in FIG. 10. Specifically, the second control lens 137 may be configured such that it is located at a focus position f of a light beam having passed through the first control lens 136, or is movable inward or outward from the focus position f along an optical axis. The light beam having passed through the first control lens 136 takes the form of a diverging light beam, converging light beam or parallel light beams in accordance with the position of the second control lens 137. Accordingly, the light beam having passed through the first control lens 136 is changed in path as it is diverged or converged toward the focus position f in accordance with the position of the second control lens 137.

The movable second control lens 137 may have a thinner thickness than that of the first control lens 136, to enable a delicate regulation in the path of a light beam. It should be noted that the control lenses of the focus control unit 135 may be a combination of convex and concave lenses, and serve to change the focus position of the light beam to be irradiated through the lens unit 40, and the configuration thereof is not limited to the embodiment of the present invention.

In conclusion, with the use of the focus control unit 35 or 135, the focus position of the light beam to be irradiated to the recording medium 50 may be changed without changing the position of the lens unit 40, and the recording medium 50 having a plurality of recording layers can be used even in a near field.

A recording medium used in a near-field recording/playback apparatus shows a remarkable reduction in thickness, and a need for a thin film type recording medium is on the rise. Hereinafter, several examples of a recording medium usable in the recording/playback apparatus of the present invention and other recording/playback apparatuses will be explained in detail.

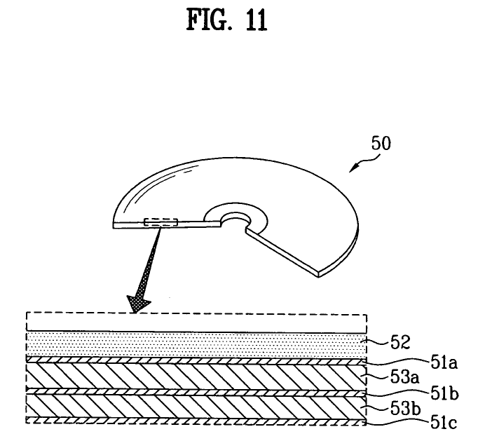

FIG. 11 is an enlarged partial sectional view and perspective view illustrating a recording medium used in the recording/playback apparatus according to the present invention. As shown, the recording medium 50 of the present invention includes one or more recording layers 51a, 51b and 51c (hereinafter, designated wholly as reference numeral 51), a protective layer 52 isolating the recording layers 51 from the outside, and spacer layers 53a and 53b (hereinafter, designated wholly as reference numeral 53) spacing the respective recording layers apart from each other. Now, these respective constituent elements will be explained in detail.

The recording layers 51 indicate layers for allowing data to be recorded therein or the recorded data to be played back therefrom by a light beam irradiated to the recording medium 50. For the convenience of explanation, in the present embodiment, the recording medium 50 including first, second, and third recording layers 51a, 51b and 51c will be explained exemplary. It should be noted that the number of the recording layers 51 is not limited to the present embodiment, and may be arbitrarily determined so long as the recording layers 51 are located in the focus depth of the light beam irradiated thereto.

The first recording layer 51a closest to a surface of the recording medium has the risk of data damage by disturbance. Accordingly, the first recording layer 51a may be provided with the protective layer 52 for isolating the first recording layer 51a from the outside.

The protective layer 52, which is used to isolate the recording layer 51 from the outside, may be formed by applying a curable resin onto the surface of the recording medium 50. Also, a lubricating layer (not shown) may be additionally provided on the protective layer 52, and the protective layer 52 may be formed on each of the recording layers 51. In the present embodiment, the protective layer 52 simply serves to isolate the uppermost exposed first recording layer 51a from the outside, and thus, is formed only on the surface of the recording medium 50.

The thickness of the protective layer 52 is determined in consideration of the following two basic factors.

Firstly, the protective layer 52 must have at least a thickness required to protect the recording layer 51 as stated above. Preferably, the thickness of the protective layer 52 is more than 10 nm at least. To resist external pollutants, it is essential to provide the protective layer 52 with the thickness more than 10 nm. Since the recording medium 50, which has a thin film shape suitable for use in a near field, substantially has no rigidity, there is a need for protecting and maintaining the shape of the recording medium 50 by use of a cartridge. For this reason, in the embodiment of the present invention, the protective layer 52 is cured to maintain the minimum rigidity of the recording medium.

Secondly, the thickness of the protective layer 52 may be determined in consideration of an allowable movement range of the lens unit 40 that is located close to the recording medium 50. As stated above, the near-field recording/playback apparatus is configured such that the lens unit 40 and recording medium 50 maintain a very close distance. More particularly, the distance between the lens unit 40 and the recording medium 50 is approximately ¼ of the wavelength λ of the light beam irradiated to the recording medium 50. For example, when using a blue light beam (having a wavelength of approximately 450˜500 nm), the distance between the lens unit and the recording medium may be maintained at a very small value of approximately 100 nm.

As will be appreciated, the irradiation position of the light beam has to be continuously changed in the course of recording or playing back data in or from the recording medium 50. That is, it is essential to horizontally move the lens unit 40 for the search of a track or movement between tracks. Although the horizontal movement of the lens unit 40 causes no problem in a far-field recording/playback apparatus, in the case of the near-field recording/playback apparatus in which the lens unit 40 and the recording medium 50 maintain a very close distance, it suffers from a collision between the lens unit 40 and the recording medium 50 if it loses the horizontality thereof even slightly.

Accordingly, the thickness of the protective layer 52 has to be determined in consideration of a range allowing the tilting of the lens unit 40, and preferably, is not more than 25 μm. When the protective layer 52 has a thickness of 25 μm, actually, the range allowing the tilting of the lens unit 40 without the risk of coming into contact with the recording medium 50 is no more than 0.07° on the basis of experimental results. This angle is obtained in consideration of maximum possible horizontality, and the lens unit 40 inevitably collides with the recording medium if the thickness of the protective layer 52 exceeds 25 μm.

Due to the reasons as stated above, in the recording medium 50 of the present invention, the thickness of the protective layer 52 is preferably in a range of 10 nm˜25 μm.

Meanwhile, a refractive index of a material constituting the protective layer 52 may be determined to be greater than the NA_{eff} of the lens unit irradiating the light beam to the recording medium 50 of the present invention. This is to prevent a total reflection as described above in relation with FIG. 3.

In the case where the recording medium 50 includes a plurality of recording layers 51, in particular, in the case of the thin-film type recording medium 50 for use in a near field, the recording layers 51 are arranged very close to one another. In this case, there is the risk in that the respective recording layers 51 may cause interference preventing the processing of data in the course of recording or playing back data therein or therefrom by a light beam irradiated thereto. Accordingly, the spacer layers 53a and 53b may be formed between the respective recording layers 51a, 51b and 51c to eliminate the risk of interference. Specifically, the recording medium 50 having three recording layers 51 according to the present embodiment may include two spacer layers 53 for spacing the respective recording layers 51 from one another. It will be appreciated that the number of the spacer layers 53 between the recording layers 51 is smaller than that of the recording layers 51 by as much as one.

The thickness of the spacer layer 53 is determined in consideration of the following basic three factors.

Firstly, the thickness of the spacer layer 53 is determined within a range not causing interference between the recording layers 51, and preferably, is more than 1 μm. That is, the spacer layer 53 having a thickness more than 1 μm is able to restrict interaction between layers, and this thickness value is less than that of a current DVD.

Secondly, similar to the above described protective layer 52, the thickness of the spacer layer 53 is determined in consideration of a range allowing the movement of the lens unit 40 located close to the recording medium 50. This is on the basis of the range allowing the tilting of the lens unit 40 as stated above. Accordingly, the thickness of the spacer layer 53 is preferably no more than a maximum of 25 μm.

Thirdly, preferably, the thickness of the spacer layer 53 is limited to the maximum 25 μm, and the sum of the thicknesses of both the protective layer 51 and spacer layer 53 is limited to the maximum 25 μm. Thereby, a distance between two recording layers closest to and farthest from a light irradiation surface of the recording medium must be no more than a range enabling regulation of spherical aberration.

Meanwhile, to irradiate a light beam to one of the first to third recording layers 51a to 51c having different focus positions from one another, it is necessary to provide an optical device, such as the above described focus control unit 35 (See FIGS. 8 and 9), on a path of the light beam to be incident on the lens unit 40. In this case, a distance between the first and third recording layers 51a and 51c closest and farthest to the light incidence surface of the recording medium must belong to a range enabling correction for spherical aberration using an optical device, such as the focus control unit 35.

Specifically, the thickness of the spacer layer 53 is determined to have the maximum value under the assumption that there are two recording layers 51, and the maximum value of the total thicknesses of the spacer layer 53 and protective layer 52 is determined such that the thickness of the recording medium 50 does not exceed a range enabling the correction of spherical aberration. When considering the above described factors, in the recording medium 50 of the present invention, the thickness of the spacer layer 53 is preferably in a range of 1 μm˜25 μm.

Preferably, a refractive index of a material constituting the spacer layer 53 may be greater than the NA_{eff} of the lens unit 40 irradiating the light beam to the recording medium 50 of the present invention. This is to prevent a total reflection by the spacer layer 53 as described above in relation with the protective layer 52.

The recording medium 50 using a near field has a limit in wavelength and therefore, is gradually reduced in thickness. Accordingly, it is necessary to limit the number of the recording layers 51 included in the recording medium 50. As stated above, the recording medium 50 of the present invention is configured such that the sum of the thicknesses of the protective layer 52 and spacer layer 53 is no more than 25 μm, and the number of the spacer layer 53 is smaller than that of the recording layers 51 by as much as one. With this configuration, the number of the entire recording layers 51 and the thickness of the recording medium 50 can be limited.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

As apparent from the above description, the present invention provides the following effects.

Firstly, according to the present invention, lenses suitable for recording/playing back data in/from a recording medium using a near field can be easily manufactured.

Secondly, it is possible to provide a recording medium suitable for use in a near-field recording/playback apparatus.

Thirdly, it is possible to provide a recording/playback apparatus usable in the case where a recording medium has a protective layer or a plurality of recording layers.

1. An apparatus for reproducing and/or recording comprising:
a lens unit comprising a first lens having a spherical aberration and a second lens for compensating for the spherical aberration of the first lens; and
a photo-detector for receiving a light beam reflected from the recording medium.

2. The apparatus according to claim 1, wherein the first lens is a part of a spherical lens and has a thickness larger than a radius of the spherical lens and smaller than a diameter of the spherical lens.

3. The apparatus according to claim 1, wherein the first lens is formed by cutting a spherical lens to be located near to a local maximum point of spherical aberration.

4. The apparatus according to claim 1, wherein the second lens has a spherical aberration having the same size as that of the first lens, but having a direction opposite to that of the first lens.

5. The apparatus according to claim 1, wherein an effective numerical aperture of the lens unit is smaller than a refractive index of a protective layer separating the one or more recording layers from the outside.

6. The apparatus according to claim 5, wherein the first lens is made of glass, and the effective numerical aperture of the lens unit is equal to or smaller than 1.85.

7. The apparatus according to claim 6, wherein the effective numerical aperture of the lens unit is equal to or larger than 1.6 and equal to or smaller than 1.85.

8. The apparatus according to claim 1, further comprising:
a focus control unit for controlling a focus position of the light beam.

9. The apparatus according to claim 8, wherein the focus control unit comprises at least one lens movable in an optical axis direction.

10. A recording/playback apparatus comprising:
a lens unit and a photo-detector, the lens unit comprising a first lens having a spherical aberration and a second lens for compensating the spherical aberration of the first lens, the photo-detector being adapted to receive a light beam reflected from the recording medium; and
a controller for generating a control signal by use of a signal generated from the photo-detector.

11. A recording medium for use in a near field comprising:
one or more recording layers; and
at least one protective layer isolating the one or more recording layers from the outside,
wherein a refractive index of the protective layer is larger than an effective numerical aperture of the lens unit.

12. The recording medium according to claim 11, wherein the protective layer is provided at a surface of the recording medium, and has a thickness in a range of 10 nm˜25 μm.

13. The recording medium according to claim 11, further comprising:
at least one spacer layer spacing the one or more recording layers apart from each other or spacing the recording layers apart from the protective layer.

14. The recording medium according to claim 13, wherein the spacer layer has a thickness in a range of 1 μm˜25 μm.

15. The recording medium according to claim 13, wherein the sum of the thicknesses of the protective layer and spacer layer is a maximum of 25 μm.

16. The recording medium according to claim 12, wherein a refractive index of the spacer layer is larger than the effective numerical aperture of the lens unit.
